(19) United States
(12) Patent Application Publication
(10) Pub. No.: US 2017/0186023 A1
(43) Pub. Date: Jun. 29, 2017

(54) SYSTEMS AND METHODS FOR PERFORMING MULTI-CHANNEL LEAD OPTIMIZATION FOR MARKETING

(71) Applicants: Lizhi Ma, Newark, DE (US); Gary Ulrich, West Trenton, NJ (US); Peiwu Zhao, Newark, DE (US); Christopher R. Conrad, Philadelphia, PA (US)

(72) Inventors: Lizhi Ma, Newark, DE (US); Gary Ulrich, West Trenton, NJ (US); Peiwu Zhao, Newark, DE (US); Christopher R. Conrad, Philadelphia, PA (US)

(21) Appl. No.: 12/099,578

(22) Filed: Apr. 8, 2008

(51) Int. Cl. G06Q 10/00; G06Q 30/02

(52) U.S. Cl. CPC G06Q 30/0202

(57) ABSTRACT

The invention provides systems and method for optimizing the utilization of multiple channels in a marketing campaign, the multiple channels each being candidates for utilization in the marketing campaign. The method is implemented on a computer system. The method may include providing a mathematical representation of the candidate channels; and providing a mathematical representation of an interrelationship between the candidate channels. Further, the method may include providing a mathematical framework to optimize the utilization of the channels, the mathematical framework incorporating the mathematical representation of the candidate channels and the mathematical representation of an interrelationship between the candidate channels. The method may further include running the mathematical framework to generate results, the results including the channels to utilize in the marketing campaign and leads to utilize in such channels; and outputting the results.

### BACKGROUND OF THE INVENTION

The systems and methods of the invention relate to performing multi-channel lead optimization for marketing.

Vendors are often faced with difficult challenges relating to applying their marketing resources in a cost effective manner. When a large number of consumers are eligible for a wide variety of products through different marketing channels, the vendors decision processes of offering which product, through which channel, for its customers become complicated and the vendor's marketing efforts increasingly costly. The vendor's cost is driven by a variety of often necessary steps including identifying potential customers, determining the viability of those customers for certain products, introducing those customers to the products and finally bringing about a transaction. These general steps require significant resources to ensure that the right products are available to the right consumers so that the transaction is positive for the buyer and profitable for the vendor.

This invention provides methods and systems to provide novel marketing techniques across multiple marketing channels, so as to extract the most value from the market, given the constraints on marketing efforts. The invention provides processing and features not available in currently known technology.

### BRIEF SUMMARY OF THE INVENTION

The invention provides systems and method for optimizing a variety of products for eligible customers and the utilization of multiple channels in a marketing campaign. The method is implemented on a computer system. The method may include providing a mathematical representation of the candidate channels; and providing a mathematical representation of an interrelationship between the candidate channels. Further, the method may include providing a mathematical framework to optimize the utilization of the channels, the mathematical framework incorporating the mathematical representation of the candidate channels and the mathematical representation of an interrelationship between the candidate channels. The method may further include running the mathematical framework to generate results, the results including the channels to utilize in the marketing campaign and leads to utilize in such channels; and outputting the results.

### BRIEF DESCRIPTION OF THE DRAWINGS

The present invention can be more fully understood by reading the following detailed description together with the accompanying drawings, in which like reference indicators are used to designate like elements, and in which:

FIG. 1 is a high level flowchart showing a multi-channel optimization process in accordance with one embodiment of the invention;

FIG. 2 is a further high level flowchart showing a multichannel optimization process in accordance with one embodiment of the invention;

FIG. 3 is a further flowchart showing details of the optimization module performing optimization processing of FIG. 2 in accordance with one embodiment of the invention;

FIG. 4 is a further flowchart showing details of the “process the results to implement campaign” processing of FIG. 2 in accordance with one embodiment of the invention;

FIG. 5 is a further flowchart showing details of the “implement results of optimization into a marketing strategy” processing of FIG. 4 in accordance with one embodiment of the invention;

FIG. 6 is a block diagram showing a multichannel processing portion in accordance with one embodiment of the invention;

FIG. 7 is a block diagram showing further details of the “optimization module” in accordance with one embodiment of the invention;

FIG. 8 is a listing showing illustrative mathematical propositions in accordance with one embodiment of the invention; and

FIG. 9 is a schematic flowchart showing aspects of the process in accordance with one embodiment of the invention.

### DETAILED DESCRIPTION OF THE INVENTION

Hereinafter, aspects of the various embodiments of the invention will be described. As used herein, any term in the singular may be interpreted to be in the plural, and alternatively, any term in the plural may be interpreted to be in the singular.

The invention provides systems and methods which offer a form of marketing optimization which intelligently allocates resources, across marketing channels, to achieve marketing objectives, in accordance with embodiments of the invention. The Multichannel Optimization Platform (MCO) of the invention, as hereinafter referred to, performs a wide variety of processing including maximizing return on marketing investment. MCO accomplishes this objective by enabling strategic management of overall customer engagements. This processing incorporates optimizing various combinations and sequences of marketing channels under various constraints including expense limits and capacity limits, for example. The method may be repeated over time to incorporate the lessons learned from the results of previously executed marketing campaigns. MCO is robust enough to address existing customers, prospective customers, existing products and cross selling of additional products. MCO also accounts for the full range of marketing channels, including active channels and passive channels. Illustratively, the marketing strategy resulting from MCO provides the following advantages:
Increase in both revenue and profitability of the marketing function;
Improved customer experience;
Enhanced customer engagement and increased retention;
Coordinated branding and messaging; and
Improved forecasting and simulation of program rollout.

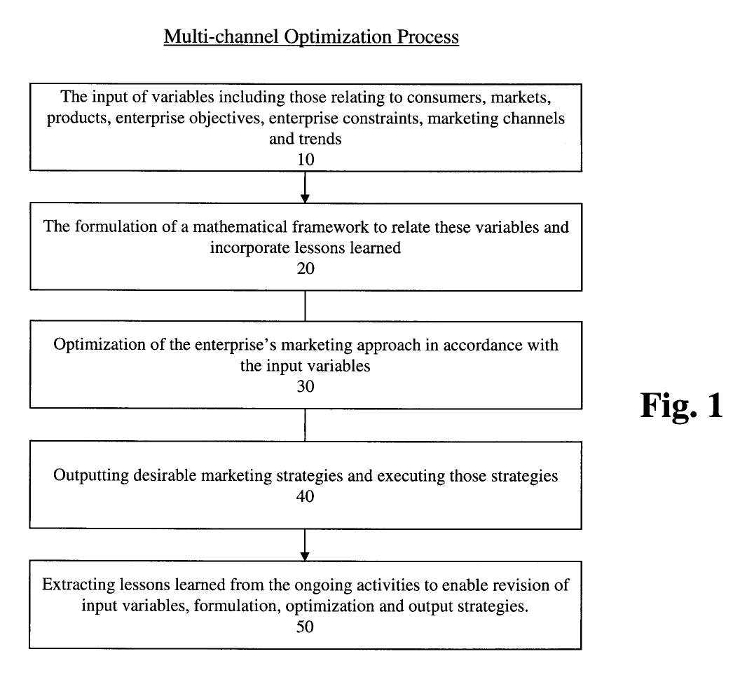

In summary, the invention provides a multi-channel optimization process and system to perform the process. FIG. 1 is a high level flowchart showing a multi-channel optimization process, and aspects thereof, in accordance with one embodiment of the invention.

As shown in FIG. 1, in accordance with one embodiment of the invention, the steps of the multi-channel optimization process may first include step 10. In step 10, the process inputs variables including those relating to consumers, markets, products, enterprise objectives, enterprise constraints, marketing channels and trends, for example. Then, the process passes to step 20. In step 20, a mathematical framework is formulated. The mathematical framework relates the variables (input in step 10) and incorporates lessons learned, i.e., data from prior optimization processing that is used to train the mathematical framework. Then, in step 30 the process optimizes the enterprise's marketing approach in accordance with the input variables. Then, the process passes to step 40. In step 40, the process outputs the desirable marketing strategies, and those strategies are executed. Then, in step 50, the process extracts lessons learned from the ongoing activities to enable revision and refinement of the mathematical framework, as well as revisions and refinement of input variables, the optimization processing, and the output strategies, for example.

A particular mathematical framework as described herein may be updated and/or refined as desired. For example, a particular mathematical framework might be updated and/or refined on a daily, weekly of monthly basis, on demand, as a result of a trigger event, or in real time, for example.

Hereinafter, the processing of FIG. 1 is discussed in further detail.

As described above, in step 10, the process inputs variables including those relating to consumers, markets, products, enterprise objectives, enterprise constraints, marketing channels and trends, for example. MCO accounts for a wide variety of marketing factors and effects. These factors and effects may be manifest as input variables including constraints, such as budget and other resources (such as a limited call center capacity, a limited number of advisors in call centers, limited number of inserts ordered for direct mail promotions, the number of vendor queues that are available for outbound marketing, and/or a limited budget for direct mail, for example); consumer behavioral estimates such as credit scores and response probabilities; consumer eligibility for products; product eligibility for channels; attrition/retention of consumers; contractual restrictions with business partners; desired marketing strategies or proven techniques; channel expense; product cost, and revenue and profit per sale, for example.

Illustratively, an example of a contractual restriction would be that the marketing strategy is allowed to promote only one commercial air carrier, i.e., that one air carrier would object if another air carrier's services were included in the marketing campaign. Thus, such restriction is to be imposed on the multi-channel optimization process.

MCO also accounts for the execution of a marketing strategy over time, and therefore input variables may have a time dimension. Such a time dimension could be used to describe (1) the sequencing of marketing campaigns and (2) the interaction between such sequences. The sequences of contacts with customers over time is part of the general concept of contact management. For example, the contact management strategy may advise to conduct two campaigns within a short period of time if they are promoting a seasonal product. The time dimension of contact management may include the effect of time on the cost of certain channels or the consumer response to certain channels. In one embodiment, the time dimension relates to the lifecycle of the account. For example, a new customer of the bank may be more responsive to promotions, and his responsiveness may decrease as time advances. Accordingly, a model utilized by the MCO, might weight the most profitable products with a heavier weighting for new accounts (assuming that a heavier weighting will reflect a greater likelihood that the product be utilized in a marketing campaign). In this manner, newer accounts are more likely to utilize the most profitable products. Such methodology is in harmony with the business reality that new customers are more likely to respond to the offering of a new product.

Further, a bank or other financial institution develops increasingly detailed information as such bank works with a particular customer over a period of time. As a result, with a person who has been a customer for some period of time, a bank may be more strategic in assessing effective market touches for that customer. For example, such customer may be weighted more heavily towards e-mail based promotions, if the customer has responded well to e-mail promotions over a period of years.

In accordance with a further aspect of the invention, the processing system of the invention may implement rules that will not allow certain practices, such as bombarding a customer with communications over multiple channels in a short time period. Thus, such rules may limit communications as to how often, relevant time periods, and variance of time periods based on sensitivities, for example. In other words, constraints may be imposed, on the models used by the CMO, so as to limit or in some way control the number or nature of the “marketing touches” to a particular customer or segment of customers.

As described above, step 20 includes the formulation of a mathematical framework to relate variables and incorporate lessons learned from prior processing. In the formulation of the underlying mathematical framework (a value framework) for the channels and the overall campaign, in accordance with one embodiment of the invention, each individual channel is described by at least one objective function. These objective functions may incorporate descriptive models such as channel response models at the customer/account level; channel propensity models at the segment/customer/account level; contact deterioration models at the segment/customer/account level; channel expense and profitability models at the segment/customer/account level; and attrition/retention models at the segment/customer/account level, for example. That is, the phrase “segment/customer/account level” meaning that such descriptive models may work at any of a segment level, or a customer level, or an account level, for example.

The models used in the optimization process describes a relationship between at least two variables observable within a channel. For example, in embodiments, the contact deterioration model relates the frequency of contact with a customer to the effectiveness of additional contacts. Further, a retention model depicts how certain patterns of contact with a customer in a certain channel affects the likelihood that the customer maintains an account with the enterprise. These descriptive models are utilized to formulate the channel objective functions and channel marketing strategies. One such strategy, for example, would be a ranking of customers to contact within a certain channel.

In accordance with one embodiment of the invention, MCO utilizes a “governor module” to synthesize the models and objective functions of the individual channels into an overall strategy. MCO also addresses the interaction effects between channels. Channel interaction effects may depend on, among other factors, the capacity of the channels and the sequencing interplay of each channel's strategy with the other channels' marketing sequences. For example, MCO also accounts for the interplay between passive and active channels (for example, billboards or direct mail, respectively). That is, a “passive channel” may be characterized as a channel via which it is not known who will call in. On the other hand, an “active channel” may be characterized as a channel via which contact is initiated by the marketing persons/system (e.g. a bank makes the call to the customer).

In accordance with one embodiment of the invention, before incorporation into the mathematical framework of MCO, interaction effects are first estimated through contact analysis that seeks to capture the nature and impact of the interactions. Contact analysis entails observation or experimentation regarding the effects of different contact methods and strategies on the market and consumers. MCO combines these interaction effects with the underlying descriptive models and objective functions of the channels to form an overall objective function. This overall objective function is based partially upon the profitability across all of the channels.

As described above, step 40 of FIG. 1 relates to output and the execution of the generated strategy. Thus, MCO produces an overall marketing strategy. Such a strategy can include many combinations of marketing actions. In summary, the strategy provides information relating to the manner in which to contact customers. In particular, such information may include instructions as to which consumers should be contacted (e.g. the profiles of customers that should be contacted; when the contact should occur; in what channel or channels the contact should occur; the interrelationship of multiple customer contacts, e.g. a mailing followed by a call, television advertisement or web advertisement; as well as other particulars of the customer contact. One example of a strategy is the use of a direct mail promotion followed up by a direct phone call, followed by a web add, followed by a further phone call, and with particular time periods between such events (and/or the particular events dependent on particular triggers) for example.

As should be appreciated, a user, i.e., an entity that will implement the strategy, may be capable of implementing some strategies, but not others. That is, a user will have particular resources at their disposal. For example, a user may have mailing capability, but not telephone call capability. The particular resources, that a user has, is input as a variable, e.g. in step 10 of FIG. 1. In this manner, the user of the MCO system is then prepared to implement the marketing strategy utilizing the marketing resources input into the initial MCO formulation, if such resources are suggested by the processing.

The MCO system provides functionality to help various types of users with the design and implementation of the marketing strategy. In one embodiment, some users are allowed access to the system via a web-based interface where they can access the output marketing strategy. Other users are allowed access to the system where they can manipulate the constraints and experiment with different marketing strategies. Another group of users can access the system to modify the settings and formulation of the system itself.

As described above, in step 50 of FIG. 1, the process extracts lessons learned from the ongoing activities to enable revision and refinement of the mathematical framework (as well as revisions and refinement of input variables, the optimization processing, and the output strategies, for example). Relatedly, the systems and methods of the invention may use various test and control techniques. Specifically, testing may be performed in the manner of performing a particular strategy or marketing campaign with particular input data, for example. That is, given data might be input into a particular marketing campaign, with optimum or desired results of the marketing campaign (with the given data) being predetermined. Thus, if the output results of running the particular data through the marketing campaign is what was expected, then the test was satisfied. On the other hand, if the results were not what was anticipated, then further adjustment, refinement and/or calibration of the particular mathematical framework may be performed. Other techniques may be utilized to develop the mathematical framework.

To explain further, the execution of the marketing strategy and observation of its effects and other environmental changes affords further opportunity to refine the MCO. MCO can incorporate observed effects of the marketing campaign into the input variables and formulation, thus yielding an updated or refined MCO formulation. For example, a marketing campaign may observe a different consumer response rate to email promotions, and therefore this new rate is factored into the MCO. For further example, perhaps an entire channel is deemed inadvisable by the results of a marketing campaign, and therefore later MCO formulations would exclude that channel, or alternatively assign the particular channel a suitable adverse weighting (so as to reflect a disfavor of the channel). Refined MCO formulations continue to function similarly to original MCO formulations. A user may choose to include such refinements of the MCO in a general cycling of the MCO method steps.

Accordingly, the invention provides a system and method which offers a form of marketing optimization which intelligently allocates resources, between channels, to achieve marketing objectives, in accordance with embodiments of the invention. Thus, the invention considers the desirability of multiple marketing channels. In embodiments, these channels refer to different approaches of introducing customers to products including, but not limited to, direct mail/catalog, online, outbound email, outbound telemarketing, inbound calls, statements and account management, web-ads, business partner mailings and communications, and cellphone/text messaging, for example.

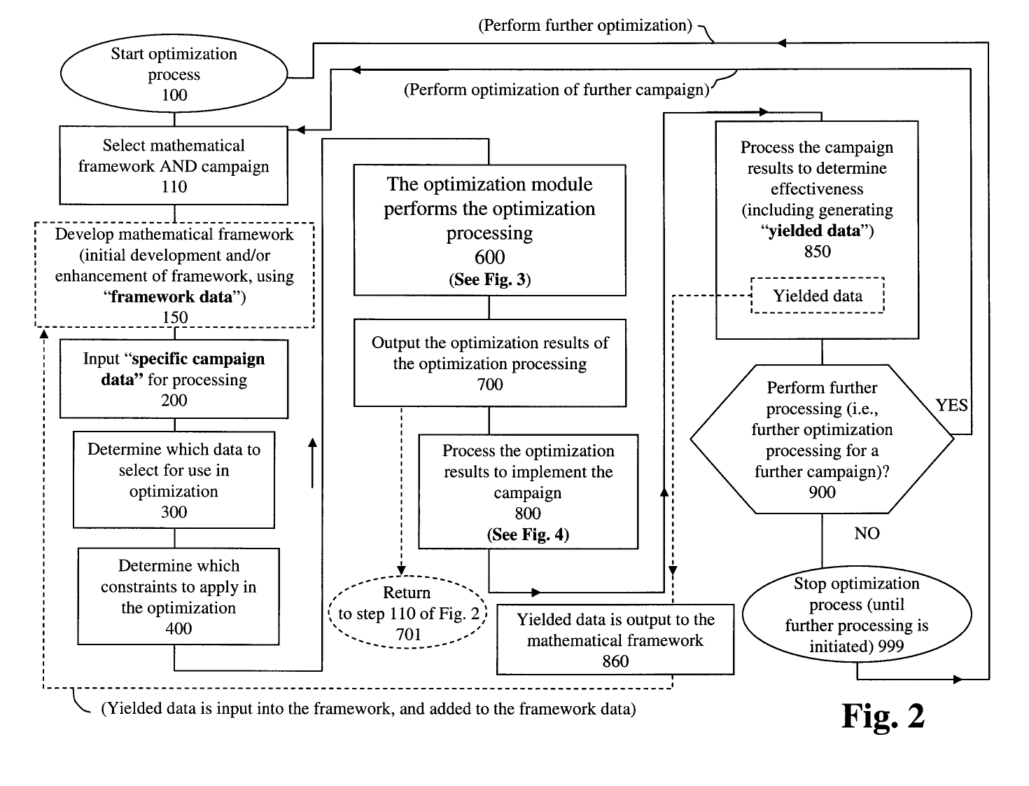

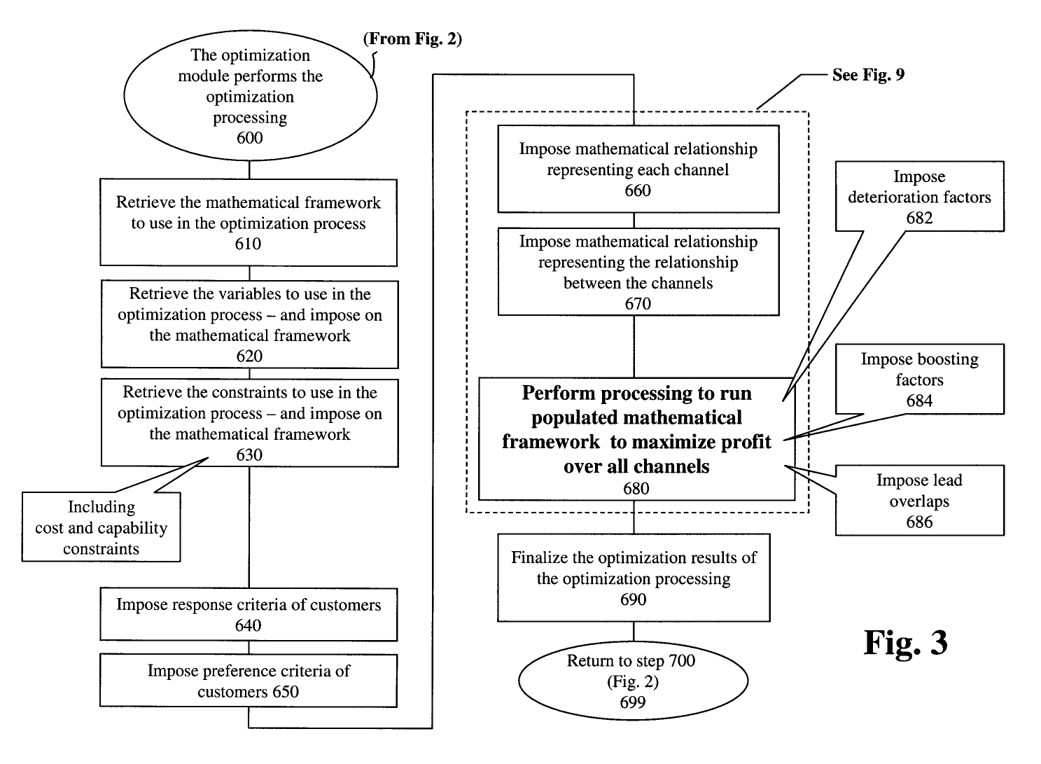

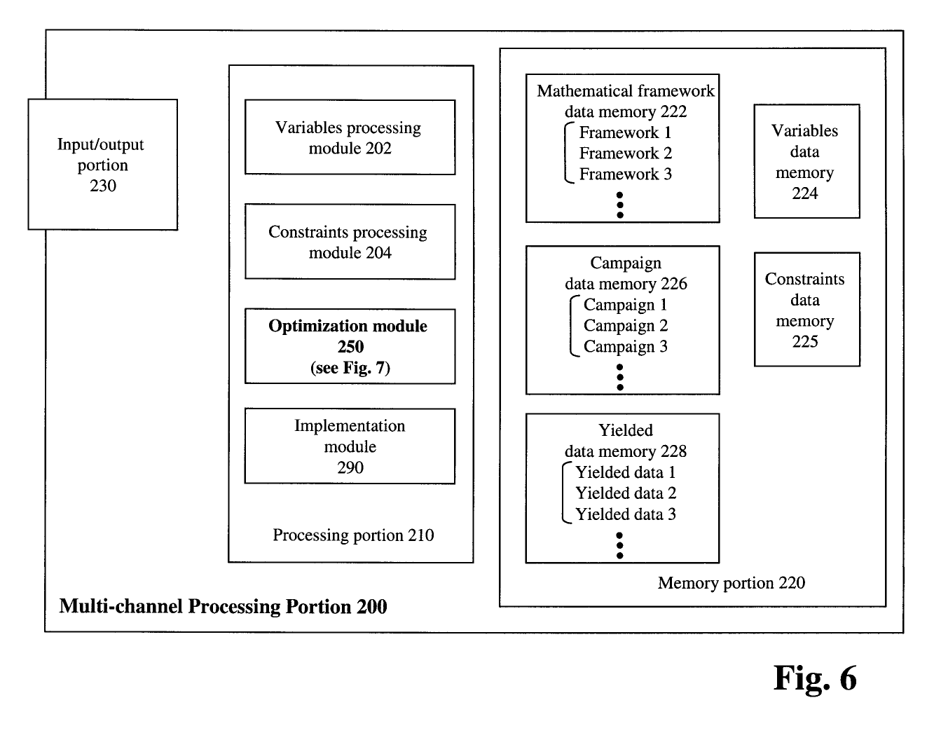

FIG. 2 is a high level flowchart showing features of the optimization process, in accordance with one embodiment of the invention. FIGS. 3-5 are flowcharts showing further details of the processing of FIG. 2. Further, FIG. 6 is a block diagram showing a multi-channel processing portion 200, in accordance with one embodiment of the invention. Illustratively, the multi-channel processing portion 200 may be used to perform the processing of FIGS. 2-5. The system of FIG. 6 will be described, and thereafter the processing of FIGS. 3-5 (which may be performed by the system of FIG. 6).

As shown in FIG. 6, the multi-channel processing portion 200 includes a processing portion 210 and a memory portion 220. The processing portion 210 performs various processing, as described below. Further, the memory portion 220 contains various data used in the processing of the processing portion 210. The multi-channel processing portion 200 also includes an input-output portion 230. The input-output portion 230 allows the multi-channel processing portion 200 to communicate with a user, as well as other processing systems.

As shown, the processing portion 210 contains various specialized processing portions, which perform processing not otherwise performed by the processing portion 210. In particular, the processing portion 210 includes a variables processing module 202, a constraints processing module 204 and an optimization module 250. The variables processing module 202 performs various processing associated with variables used in the optimization process, such as selection and population of the variables (depending on related parameters). For example, the selection of the variables may depend on criteria selected by the user or imposed by a particular model or marketing campaign being processed. The constraints processing module 204 performs various processing related to the constraints, such as determining which constraints should be imposed (depending on related parameters).

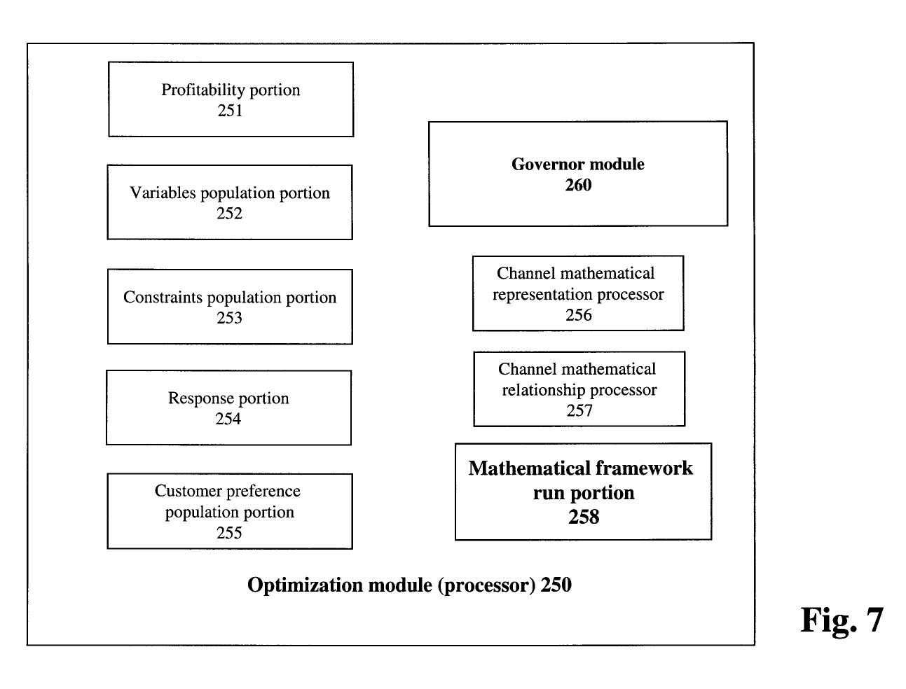

The optimization module 250 is the module that performs the optimization processing. The optimization module 250 utilizes the variables output by the variables processing module 202 and the constraints output by the constraints processing module 204. Further details of the optimization module 250 are described below, with reference to FIG. 7.

As shown in FIG. 6, the memory portion 220 contains various specialized memory portions, which retain data (i.e., information) not otherwise retained by the memory portion 220. In particular, the memory portion 220 includes a mathematical framework data memory 222, a variables data memory 224, a constraints data memory 225, a campaign data memory 226, and a yielded data memory 228.

In further explanation, the mathematical framework data memory 222 contains data representing one or more mathematical frameworks, which are selectively used in the optimization of a particular marketing campaign. Such data may take on a wide variety of forms, as described herein. The variables data memory 224 contains data relating to the variables used in the processing, including values for the variables. The constraints data memory 225 contains data representing various constraints to be imposed by the optimization processing. Further, the campaign data memory 226 contains data that is unique to the particular campaign currently being processed. Lastly, the yielded data memory 228 is data that is collected in conjunction with implementation of a particular marketing strategy, i.e., the yielded data is learned data. The yielded data may be put back into the mathematical framework (or in some manner the yielded data may be reflected by a refinement of the mathematical framework), so as to improve the mathematical framework. Thus, in such manner, the yielded data becomes mathematical framework data. For example, the yielded data might be used to refine weightings used in the mathematical framework.

Hereinafter, further details of the optimization module 250 will be described with reference to FIG. 7.

As shown in FIG. 7, the optimization module 250 performs various processing to perform the multi-channel optimization, as described herein. The optimization module 250 includes a profitability portion 251, a variables population portion 252, a constraints population portion 253, a response portion 254, a customer preference population portion 255, a channel mathematical representation processor 256, a channel mathematical relationship processor 257, and a mathematical framework run processor 257.

Further details of such components are described below. However, in summary, the profitability portion 251 populates the mathematical framework, which is being used, with a mathematical representation of profits (e.g. based on relevant inputs and constraints, for example). The variables population portion 252 populates the particular mathematical framework, which is being used, with the various variables needed for the optimization processing. In a similar manner, the constraints population portion 253 populates the mathematical framework with the various constraints needed for the optimization processing. The response portion 254 retrieves and populates the mathematical framework with customer response information. The customer preference population portion 255 retrieves and populates the mathematical framework with customer preference information.

The channel mathematical representation processor 256, in the optimization module 250 of FIG. 7, generates and/or processes a mathematical “representation” of each channel to be considered in the optimization process. Further, the channel mathematical relationship processor 257 generates and/or processes a mathematical representation of the “relationship” between the channels to be considered in the optimization process.

Such generation and processing performed by the channel mathematical representation processor 256 and the channel mathematical relationship processor 257 might include inputting a mathematical representation of the relationships, or alternatively, inputting a portion of the mathematical representation (and/or data used in the mathematical relationship) and combining such with preexisting data. That is, for example, the channel mathematical representation processor 256 and the channel mathematical relationship processor 257 might utilize template mathematical relationships. These template mathematical relationships might then be customized based on data associated with the particular campaign, data associated with the particular optimization processing, data input by a user, and/or other data.

The optimization module 250 also include the mathematical framework run processor 257. Once the variables, constraints, various mathematical relationships and other parameters are in place, the mathematical framework run processor 257 runs the optimization routine, i.e., runs the mathematical framework. In particular, the mathematical framework may be in the form of a linear program, for example. The optimization module 250 may utilize optimization technology such as CPLEX or MARKET SWITCH, for example.

The optimization module 250, as shown in FIG. 7, also include a governor module 260. As described otherwise herein, the governor module 260 serves to essentially arbitrate across channels. In other words, an optimization process as described herein may be performed so as to determine the favored leads in a particular channel, i.e., optimizing that channel in and of itself. These favored leads are then pushed up to the governor module 260. Also, favored leads from other channels (as a result of an optimization in those other channels) are pushed up to the governor module 260.

The governor module 260 optimizes (i.e., arbitrates) across the multiple channels so as to optimize the leads looking at the totality of channels under consideration. Thus, some leads that were selected as candidates when looking at a single channel, might very well not be ultimately selected once the governor module 260 arbitrates which leads to select (i.e., when looking across channels at all the leads under optimization).

Hereinafter, a process in accordance with one embodiment of the invention will be described with reference to FIG. 2. As described, the process of FIG. 2 is performed by the multi-channel processing portion 200 of FIG. 6. However, other suitable systems, having a different arrangement, in accordance with the invention, might also perform the processing of FIG. 2.

As shown, the optimization process starts in step 100 and passes to step 110. In step 110, the particular mathematical framework and the particular campaign, which is to be used, is selected. This selection process might be performed automatically in some manner (such as based on predetermined criteria) or the selection process might be performed manually, or alternatively may include both automatic and manual selection processing.

After step 110, the process passes to step 150. In step 150, the process develops a mathematical framework. Such step 150 may include initial development of a mathematical framework (for a particular marketing campaign) and/or enhancement of the mathematical framework, i.e., based on yielded information secured from other prior marketing campaigns. However, alternatively, it may well be that the mathematical framework, which is to be used, is already completed.

The multi-channel processing portion 200 and method of FIG. 2 utilizes different types of data as described herein. As used herein, “framework data” is data that goes to make up the mathematical framework. That is, the mathematical framework is formed by framework data. “Specific campaign data” as used herein is data that is input into the multi-channel processing portion 200 for a particular marketing campaign. Further, “yielded data” is data that is yielded from a particular marketing campaign, i.e., data that is learned from a marketing campaign. As described below, yielded data might be used to refine the framework data.

After step 150 of FIG. 2, the process passes to step 200. In step 200, the input-output portion 230 in the multi-channel processing portion 200 inputs “specific campaign data” for processing. The specific campaign data might be input from a human administrator (via a user interface) or from another processing system, for example. After step 200, the process passes to step 300.

In step 300, the variables processing module 202 determines which data is to be used in the requested optimization process. That is, in accordance with one embodiment of the invention, the variables processing module 202 retrieves the needed data based on the particular mathematical framework (that is being used) and any particulars of the specific campaign being optimized. Thus, the particular mathematical framework and campaign (which is selected in step 110) will dictate which variables are used in the optimization process. The variables processing module 202 outputs the variables, to be used, to the optimization module 250.

Then, in step 400, the multi-channel processing portion 200 determines which constraints to apply in the optimization 400, i.e., based on the mathematical framework and campaign selected in step 110, for example. Thereafter, the constraints processing module 204 outputs the constraints to the optimization module 250.

Then, in step 600, the process passes to operation of the optimization module 250. Specifically, in step 600, the optimization module 250 performs the optimization processing. Further details of the optimization processing are described below with reference to FIG. 3. Accordingly, in step 600, the results of the optimization processing are generated.

After step 600, the process passes to step 700. In step 700, the process outputs the results of the optimization processing. The output of the results may typically be in the form of a data set, output to a suitable operating system, e.g. such as the implementation module 290. The implementation module 290 (or other system) implements the campaign based on the optimization results. Thus, the implementation module 290 effects the various steps associated with the particular campaign, including, the steps that should be performed for each channel (which is to be utilized). For example, based on the optimization results, the implementation module 290 may control processing including effecting mailings, including inserts in promotional items, showing web adds, sending e-mails, prompting telephone communications, waiting for predetermined time periods, controlling the sequence of which channels are used and when, and controlling the customers that are contacted (and in what manner particular customers are contacted). The implementation module 290, in implementing the campaign, may utilize other systems and/or dictate the action of persons.

Accordingly, the implementation module 290 carries out the campaign over some period of time. At a point in time, the campaign will draw to a close, or at least be sufficiently advanced, such that results of the campaign may be analyzed in some constructive manner. Accordingly, in step 850, as shown in FIG. 2, the campaign results are processed to determine the effectiveness of the campaign. The effectiveness of the campaign may be analyzed on a per channel basis. Further, the effectiveness of the campaign may be measured in a variety of ways using different metrics. Such metrics of success might include profit per channel, profit of the campaign overall, profit of a particular sequence of marketing over different channels, sales objectives, attrition/retention objectives, the attainment of a critical mass of some parameter, and the attainment of a desired customer response over a channel or channels, for example. Based on the analysis of the campaign, data is generated that is herein referred to as “yielded data.” As shown by step 860 of FIG. 2, the yielded data (or a portion of the yielded data), in accordance with one embodiment of the invention, is then input back to the mathematical framework. In particular, the yielded data is utilized to modify the mathematical framework, so as to enhance the performance of the mathematical framework in a subsequent campaign. For example, the yielded data might be used to adjust the constraints, the customer preferences, weightings and/or the customer eligibility.

After step 850 (and step 860), the process passes to step 900. In step 900, the process performs decisioning as to whether further optimization processing will be performed for a further campaign. For example, such decisioning might be performed in some automated manner, the decision might be input from another system, or the decision might be input from a human administrator. If YES in step 900, i.e., there is further optimization processing to be performed, then the process returns to step 110. Thereafter, the processing is performed as described above.

On the other hand, if the decision is NO in step 900, i.e., there is not further optimization processing to be performed, then the process passes to step 999. In step 999, the optimization process ends, i.e., until further processing is effected. That is, step 900 (of FIG. 2) reflects the particular situation that a further optimization might be in queue for processing. On the other hand, step 999 generally reflects that optimization processing may be performed repeatedly in any suitable manner, as desired. For example, a desired optimization process may be performed in some periodic manner, such as daily, weekly, or monthly, for example. A desired optimization process might be performed in response to some triggering event, such as a certain number of sales being effected, the initiation of another sales campaign, or the attainment of a particular threshold value for a particular parameter. Further, a desired optimization process might simply be initiated based on a request of a sales coordinator, for example. In particular, this might be the case where a sales coordinator (or other person) is exploring sales strategies. Accordingly, it is appreciated that the optimization processing as set forth herein may be performed as desired, based on some schedule, based on the occurrence of some event, and/or based on some other parameter, for example.

Indeed, in accordance with one embodiment of the invention, after 700 of FIG. 2, the method may pass to step 701. In step 701, the method passes back to step 110 without implementation of the results. This might be desirable in a variety of circumstances, such as in a test run situation, when a product is discontinued, or when (for some reason) it is deemed that the optimization should be re-run, for example. Review of the optimization results may be performed in conjunction with step 701.

As discussed above, in step 600 of FIG. 2, the optimization processing is performed. In accordance with one embodiment of the invention, the optimization processing is performed by the optimization module 250. FIG. 3 illustrates further details of the optimization process. As shown, the process starts in step 600, and passes to step 610. In step 610, the optimization module 250 retrieves the mathematical framework to use in the optimization process. The particular mathematical framework that is retrieved may be based on parameters in the request, user selection, predetermined criteria or other criteria. After step 610, the process passes to step 620.

In step 620, the optimization module 250 retrieves the variables to use in the optimization process, and imposes the variables on the mathematical framework 620. This processing may be done by the variables population portion 252. Then, in step 630, the constraints population portion 253 (of the optimization module 250) retrieves the constraints to use in the optimization process. Further, the constraints population portion 253 imposes the constraints on the mathematical framework. The constraints might include cost constraints, capability constraints, as well as other constraints. Then, the process passes to step 640.

In step 640, the response portion 254 retrieves response criteria from the memory portion 220 and imposes the response criteria on the mathematical framework. Likewise, the customer preference population portion 255, in step 650, retrieves preference criteria from the memory portion 220 and imposes the preference criteria on the mathematical framework. After step 650, the process passes to step 660.

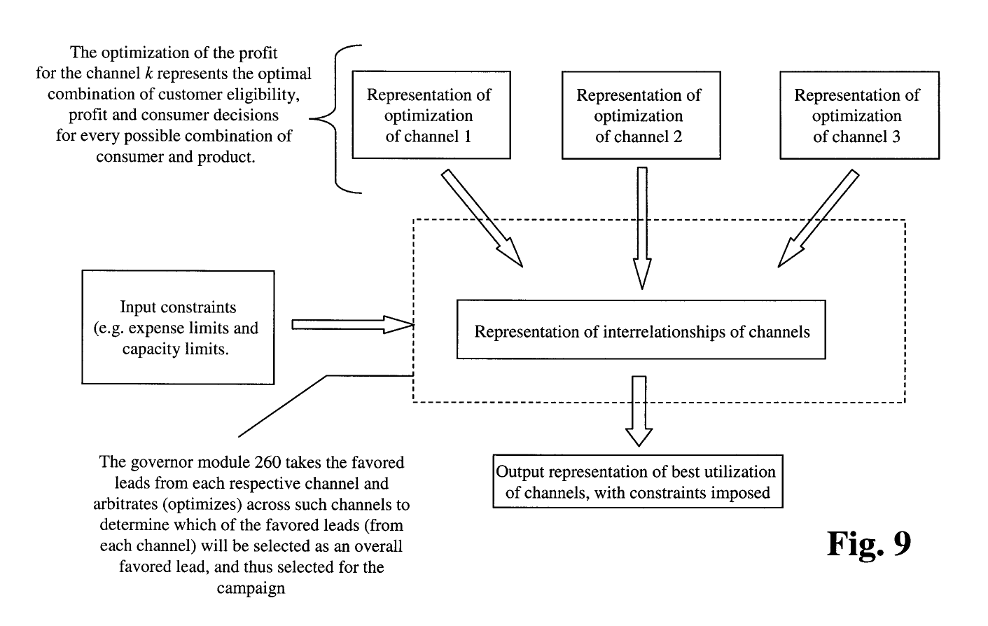

In step 660, the channel mathematical representation processor 256, of the optimization module 250, imposes a respective mathematical relationship representing each channel that is under consideration. Then, in step 660, the channel mathematical relationship processor 257 imposes a mathematical relationship representing the relationship between the channels. The processing of steps 660 and 670, as well as step 680, is further described below with reference to FIG. 9. Further, in the processing of steps 660 and 670, the profit portion, in accordance with one embodiment, imposes mathematical data into the mathematical framework representing profit of the particular marketing campaign, and the manner in which parameters and constraints affect such profit.

Accordingly, in accordance with the embodiment of the invention shown in FIG. 3, after step 670, the various constraints, variables, customer eligibility criteria, preference criteria, and mathematical relationships of the channels, and interrelationship between the channels, has been imposed on the mathematical framework. FIG. 3 shows that yet further criteria may be imposed on the mathematical framework. Specifically, the mathematical framework run processor 257 may impose deterioration factors in step 682, may impose boosting factors in step 684, and may impose lead overlaps in step 686, i.e., a mathematical representation of the manner in which utilization of a lead in one channel overlaps or affects the use of a lead in another channel, for example.

It follows that in step 680, the mathematical framework run processor 257 performs processing and runs the populated mathematical framework to maximize profit over all channels. Various further aspects of this processing, including a more mathematical based description, is set forth below.

After step 680, the process passes to step 690. In step 690, the optimization module 250 finalizes the optimization results of the optimization processing. Such finalization might include generating a desired data set, a desired database, and/or a desired report, for example.

The particular results of step 690, and the parameters in the results, may well vary between different optimization processes. The results may include information such as what channels to use, what products to sell over which channels, the sequence in which to utilize the channels, the particular type of customers to extend the offers to, which specific customers to extend the offers to, and the timing of the offers, as well as other information regarding implementation of the campaign.

After step 690 of FIG. 3, the process passes to step 699. In step 699, the process returns to step 700 of FIG. 2. Processing then continues, as described above.

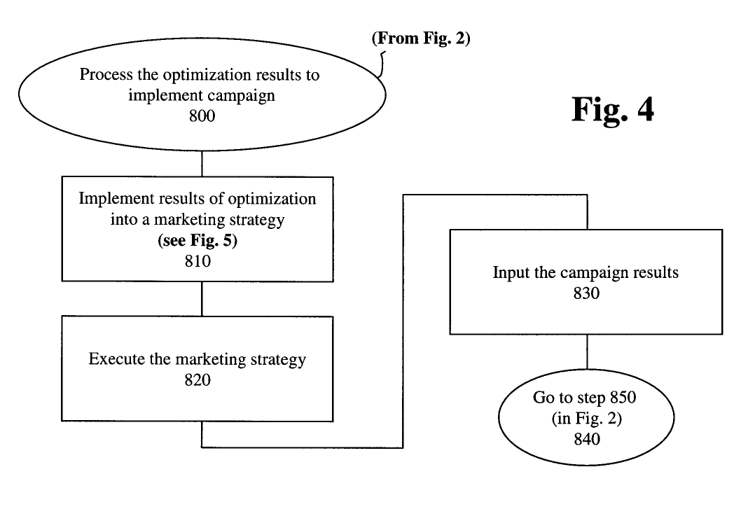

FIG. 4 is a further flowchart showing details of the “process the results to implement campaign” processing of FIG. 2 in accordance with one embodiment of the invention.

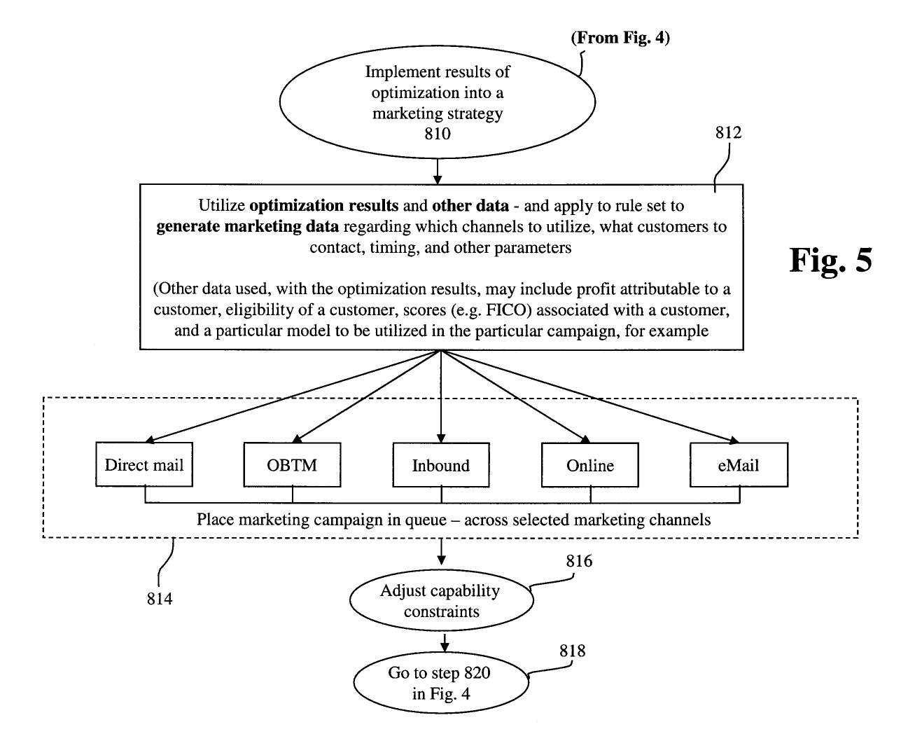

As shown, the process starts in step 800, and passes to step 810. In step 810, the process implements the results of the optimization into a marketing strategy. Further details of such implementation are set forth in FIG. 5 and described below.

Thereafter, in step 820, the marketing strategy, as developed in step 810, is executed. Execution of the marketing strategy, i.e., execution of the marketing campaign, may be over a period of time, such as weeks or months. At a point in time, the marketing campaign will be completed, or advanced sufficiently, such that results from the marketing campaign (i.e., the campaign results) may be assessed in some useful manner. This is reflected in step 830, in which the campaign results are input. In particular, the campaign results may then be used as yielded data, and utilized to modify the mathematical framework, as described above.

After step 830, the process passes to step 840. In step 840, the process returns to the processing of FIG. 2 and step 850 (of FIG. 2).

FIG. 5 is a further flowchart showing details of the “implement results of optimization into a marketing strategy” processing of FIG. 4 in accordance with one embodiment of the invention.

As shown, the process starts in step 810 and passes to step 812. In step 812, the process includes the implementation module 290, in one embodiment, utilizing the results to generate marketing data to utilize in the multi-channel. In particular, the marketing data includes, for example, information such as what channels to utilize, channel sequence information, timing information, and customer information, i.e., what customers to engage with via the determined channels. In accordance with one embodiment of the invention, the results of the optimization determination is applied to a rule set, and in turn, the results of running the optimization results against the rule set generates the marketing data. In other words, in accordance with one embodiment of the invention, a further processing step is needed to take what might be characterized as “raw data” (from optimization processing) to usable results (so as to implement a campaign). One example is that the optimization results might dictate to target family members of particular customers (in conjunction with other parameters). Thus, a rule would then be used so as to specify who exactly constituted such a family member. In general, it is appreciated that further rules may be overlaid over the results of the optimization processing, so as to generate the ultimate leads to use.

Relatedly, in accordance with some embodiments of the invention, other data may be used in conjunction with the optimization results. That is, the optimization results (and possibly further rules) may be applied to various data so as to generate the marketing data. Such other data may include various information including profit attributable to a customer, eligibility of a customer, scores (e.g. FICO) associated with a customer, other accounts and relationships with the bank, length and depth of relationship with the bank, family member's relationships with the bank, and a particular model to be utilized with the particular customer, for example.

After step 812 of FIG. 5, the process passes to step 814. In step 814, the implementation module 290 places the marketing campaign in queue, so as to align for implementation of the marketing campaign at some future time. Accordingly, step 810 is performed in preparation for the execution of the marketing strategy (that occurs in step 820 of FIG. 4). Step 814 illustratively shows that a variety of marketing channels may be used, including direct mail, OBTM (outbound telemarketing), inbound marketing, online, and e-mail, for example.

After step 812, the process passes to step 816. In step 816, the implementation module 290 adjusts the capability constraints, i.e., in that marketing resources have been allocated as a result of placing the marketing campaign in queue. Accordingly, when further optimization processing is performed, such adjusted capability constraints will be reflected in the processing of step 630 (see FIG. 3).

As shown in FIG. 5, after step 816, the process passes to step 818. In step 818, the process proceeds to step 820, in FIG. 4.

Hereinafter, the processing in accordance with embodiments of the invention will be hereinafter described more from a mathematical perspective.

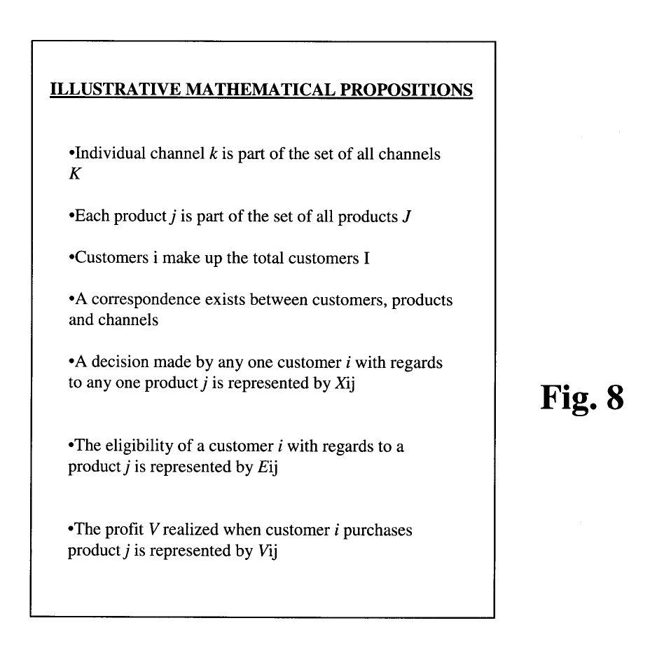

FIG. 8 is a listing showing illustrative mathematical propositions in accordance with one embodiment of the invention. The mathematical propositions are described in turn below.

Further, FIG. 9 is a schematic flowchart showing aspects of the process in accordance with one embodiment of the invention. In particular, FIG. 9 shows further aspects of the optimization process. From a mathematical perspective, the optimization of the profit for a channel k represents the optimal combination of customer eligibility, profit and consumer decisions for every possible combination of consumer and product. As shown, a mathematical representation of each of the channels is generated. Such representations of the respective channels are then used in conjunction with a mathematical representation of the interrelationship of the channels. Inputs are then overlaid over the mathematical representations, including, for example, constraints (such as expense limits and capacity limits). Thereafter, the mathematical representation (including the mathematical representation of each channel and of the interrelationship between the channels) is processed by a suitable computer system, such as the multi-channel processing portion 200. Inclusive in such processing is the processing of the governor module 260. That is, the governor module 260 takes the favored leads from each respective channel and arbitrates (optimizes) across such channels to determine which of the favored leads (from each channel) will be selected as an overall favored lead. Such overall favored leads will thus be the “best of the best” based on the optimization processing, and thus will be selected for the campaign.

As a result of this processing, the multi-channel processing portion 200 outputs a representation of the best utilization of the channels, with constraints imposed. Hereinafter, further aspects of the mathematical processing will be described.

As described above, a variety of channels may be considered for a particular marketing campaign. More specifically, from a mathematical perspective, each individual channel k is part of the set of all channels K.

These channels are used to promote one or more products. In the case of a variety of products, each product j is part of the set of all products J. Customers i are individual entities capable of purchasing these products. There are a total of I individual customers i. In other embodiments, customers may be grouped according to similar attributes or differentiated according to dissimilarities.

A correspondence exists between customers, products and channels and this correspondence has a variety of forms. For example, a customer (i^{c}) may be accessible through various channels (k^{x}, k^{y} and k^{z}, representing an email channel, phone channel and billboard channel, respectively) and/or interested in a variety of products (j^{m} and jⁿ, representing credit cards and brokerage accounts). Likewise, some products may be marketable through a certain channels, but not marketable through other channels, and thus impose a constraint on a representation of the relationship.

Another such correspondence is the product choice made by a customer. For example, customer i may choose to purchase product j. This is a discrete “yes” or “no” choice for that specific product. Customer i makes such a choice X (either “yes” or “no”) with regards to all products J, and each decision is represented accordingly. Each decision made by any one customer i with regards to any one product j is represented by Xᵢⱼ. In other embodiments the customer may merely develop a relative preference for a product as opposed to this discrete choice. Further, the decision variable X for customer i with product j may be different in different channels (k). In some embodiments this is represented as Xᵢⱼₖ.

Another correspondence factor considered by this embodiment is the eligibility of customers for certain products. For example, customers with low credit ratings are not eligible for low interest loans. Further, all customers are eligible to purchase golf balls. The eligibility of a customer i with regards to a product j is represented by Eᵢⱼ. This is a discrete “yes” or “no” eligibility determination. Other embodiments allow for eligibility determinations other than a strict “yes” or “no” such as the prioritization of customers. Further, in some embodiments, eligibility for customer i and product j is different in different channels k. This eligibility is represented by the variable Eᵢⱼₖ. A “do not call list” creates an example of differing eligibility between channels where a product may be offered through direct mail but not through a direct call to the customer.

This embodiment describes a “lead” L as a particular combination of a customer's eligibility and the customer's product choice. A favorable lead represents a situation where a customer i has chosen a product j for which the customer is eligible. Such a lead is indexed as Lᵢⱼ. The number of leads for a product is equal to the total number of customers i who chose that product and are also eligible for that product. This is expressed:

$${\sum }_{1 \leq i \leq I} {E}_{ij} \cdot {X}_{ij} = {L}_{j}$$

$$where$$

$${L}_{j} = Leads for product j$$

Where:

Eᵢⱼ=Customer i's eligibility for product j

Xᵢⱼ=Decision made by customer i with regards to product j

The enterprise recognizes a profit (whether positive or negative) when a customer purchases a product. The profit V realized when customer i purchases product j is represented by Vᵢⱼ. In other embodiments the profit may be standard in certain circumstances such as for similar customer types or products. In some embodiments, the profit for customer i and product j may be different in different channels k, and this profitability may be represented as Vᵢⱼₖ.

In understanding the multi-channel optimization (MCO) platform, an understanding is established as to how a single channel functions at one specific time period. The one specific time period may encompass any duration of time. In one embodiment, the time period is a calendar month, in another embodiment the time period is a fiscal quarter. However, any duration of time may be used as the “specific time period.” The following explains how one embodiment seeks to maximize profits for a single channel. Profit occurs when a customer is eligible for a product and decides to purchase that product. The profit for a specific customer i and product j combination is represented by the multiplication of the associated variables:

Profit for specific customer i and product j=Eᵢⱼ·Vᵢⱼ·Xᵢⱼ

Where:

Eᵢⱼ=Customer i's eligibility for product j

Vᵢⱼ=Profit realized when customer i purchases product j

Xᵢⱼ=Decision made by customer i with regards to product j

The profit for the entire channel is therefore equivalent to the sum of all of the profits for each customer i and product j combination. Single channel profit for channel k is represented Vₖ, where:

$${V}_{k} = {\sum }_{1 \leq i \leq I , 1 \leq j \leq J} {E}_{ij} \cdot {V}_{ij} \cdot {X}_{ij} = single channel profit for channel k$$

Where:

Eᵢⱼ=Customer i's eligibility for product j

Vᵢⱼ=Profit realized when customer i purchases product j

Xᵢⱼ=Decision made by customer i with regards to product j

The optimization of the profit for the channel k represents the optimal combination of customer eligibility, profit and consumer decisions for every possible combination of consumer and product. In accordance with embodiments of the invention, the optimization is depicted mathematically and the actual computations can be conducted using a computer with appropriate optimization software. The optimization may be executed according to the following objective function:

$${V}_{max} = Max {\sum }_{1 \leq i \leq I , 1 \leq j \leq J} {E}_{ij} \cdot {V}_{ij} \cdot {X}_{ij} = maximum profit for single \text{-} channel$$

Where:

Eᵢⱼ=Customer i's eligibility for product j

Vᵢⱼ=Profit realized when customer i purchases product j

Xᵢⱼ=Decision made by customer i with regards to product j

The optimization of a channel's profits is of course constrained by numerous business, financial, practical and other limitations. In this embodiment these limitations include that each customer must decide to purchase exactly one discrete product. Such a constraint is represented:

$${\sum }_{1 \leq j \leq J}^{ } {X}_{ij} = 1$$

$${X}_{ij} = \{ 0 or 1 \}$$

where “1” represents a decision to purchase, and “0” a decision not to purchase.

Further, as stated previously the eligibility threshold is a discrete threshold where the consumer i is either allowed or not allowed to purchase product j. Therefore eligibility is constrained accordingly:

Eᵢⱼ={0 or 1}

where “1” represents eligibility, and “0” represents non-eligibility.

In embodiments, the single-channel optimization objective function can account for many other factors and associated constraints. For example, the model may depict expenses and profitability separately. Also, the attrition and retention of consumers may affect the objective function. Further, contact deterioration may serve as a basis for describing the objective function. The sequencing of marketing in a channel may also be represented in the strategy. Additionally, channel capacity may be constrained.

Two further examples include the use of channel response models at the customer/account level and/or channel propensity models at the segment/customer/account level. A response model determines the probability that a customer will respond to a certain product offer in a given channel. A propensity model determines how an offer in one channel affects the responsiveness of a similar offer in a different channel. Response and propensity models may take into account the effectiveness of planned sequences of offers across different channels.

Multi-channel optimization seeks to maximize the total profit across the channels. MCO does not simply sum the independent total profits across the channels, but considers additional factors. For example, the MCO objective inherits aspects of the single-channel optimization described above and includes all aspects of a vendor's offerings such as current products and their markets, prospects for new products and the cross-sell of additional products between markets. Further, the enterprise may factor segment/customer/account treatment goals and contact management strategies into MCO.

In MCO, channels have respective capacities or volumes. In one embodiment, the capacity is defined by the number of leads within that channel. For channel k the capacity Cₖ is equivalent to the total of all product leads Lⱼ in channel k for each product j. This relationship is expressed:

$${C}_{k} = {\sum }_{1 \leq j \leq J} {L}_{j}^{k} = capacity of channel k$$

Where, Lⱼ^{k}=Product leads for product j in channel k

The overall capacity for all channels in MCO is not necessarily a simple sum of the independent capacities for all channels. For example, a lead in one channel affects the lead in another channel. Therefore, MCO incorporates an understanding of the overlaps of leads between channels, and this overlap has many possible applications in MCO. The overlap in leads between one channel k on another channel k0 is Cₖₖ₀. In one embodiment, MCO chooses to follow leads in one channel as opposed to other leads in other channels. In one embodiment, the selection of a lead is accomplished by the optimization scheme that maximizes bank profit while satisfying all marketing constraints. In one embodiment, the choice of leads among the channels, i.e., across the multiple channels under consideration, occurs in the “governor module” 260.

One embodiment of MCO includes a deterioration factor of the channels on other channels. This deterioration factor represents a variety of underlying deterioration causes. One such cause for a deterioration factor is that the sale of a product to a customer should not be double counted if the customer is reached through two different channels but only purchased a single product. The deterioration factor for channel k on channel k0 is αₖₖ₀^{D}.

Boosting factors are the complement of deterioration factors. In one embodiment the boosting factor represents the added effectiveness of contacting a customer through multiple channels. αₖₖ₀^{B} represents the boosting factor of channel k on channel k0. The profit for a channel in MCO is based on these additional factors. In one embodiment the profit for channel k0, CVₖ₀, is modified by these factors to yield the modified total profit for channel k0, CVₖ₀*. This embodiment specifically utilizes boost factors, deterioration factors and lead overlaps to modify the total profit for channel k0. Such a modification is expressed:

$${CV}_{k 0}^{*} = {CV}_{k 0} \cdot {\prod }_{k \neq k 0} ( 1 + {α}_{kk 0}^{B} {C}_{kk 0} ) ( 1 - {α}_{kk 0}^{D} {C}_{kk 0} ) = modified total profit for channel k 0$$

$${CV}_{k 0} = {CV}_{k 0} \cdot {\prod }_{k \neq k 0} ( 1 + {α}_{kk 0}^{B} {C}_{kk 0} / {C}_{k 0} ) ( 1 - {α}_{kk 0}^{D} - {C}_{kk 0} / {C}_{k 0} )$$

Where:

CVₖ₀=Profit for channel k0

αₖₖ₀^{B}=Boosting factor of channel k on channel k0

αₖₖ₀^{D}=Deterioration factor for channel k on channel k0

Cₖₖ₀=Overlap of leads between one channel k on another channel k0

The goal of MCO is to maximize profit across the channels, and therefore the objective seeks the maximum profit for the aggregation of the channels. This objective is expressed:

$$Max {\sum }_{1 < k \leq K} {CV}_{k} = multi \text{-} channel maximum profit$$

It is appreciated that the systems and methods of embodiments of the invention may well be used in conjunction with other known processing techniques and/or systems. For example, the systems and methods of embodiments of the invention may well be used in conjunction with the various teachings of U.S. patent application Ser. No. 09/564,783 filed on May 4, 2000, (Attorney Docket Number 72167.000176), and the related WO 01/37136 (published May 25, 2001) which claims priority thereto, both of which are incorporated herein by reference in their entirety. The various features as described in such applications may be used in conjunction with the various features described herein.

Hereinafter, further aspects of implementation of the invention will be described. As described above, FIGS. 6 and 7 show embodiments of a system of the invention. Further, FIGS. 1-5, and 9 show various steps of one embodiment of the method of the invention.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the invention.

It is appreciated that in order to practice the method of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

1. A method for optimizing the utilization of multiple channels in a marketing campaign, the multiple channels each being candidates for utilization in the marketing campaign, the method implemented on a tangible embodied computer, the method comprising:
providing, by the computer, a mathematical representation of each of the candidate channels;
providing, by the computer, a mathematical representation of an interrelationship between the candidate channels;
the computer automatically modifying the mathematical representation of the interrelationship between the candidate channels based on one or more prior occurrences;
the computer optimizing a utilization of the channels based on a mathematical framework that incorporates the mathematical representation of the candidate channels and the mathematical representation of interrelationship between the candidate channels;
the computer automatically modifying the mathematical framework based on feedback from marketing campaign results of prior iterations of the mathematical framework;
the mathematical framework including:
a response model that determines the probability that a customer will respond to a certain product offer in a given channel; and
a propensity model that determines how an offer in one channel affects the responsiveness of a similar offer in a different channel, and running the propensity model including the computer adjusting a calculated profit for each channel based on (a) reducing calculated profit for a channel based on a product of overlap of channels and a deterioration factor, and (b) increasing calculated profit for the channel based on a product of overlap of channels and a boosting factor;
running, by the computer, the mathematical framework to generate results, including running said response model and running said propensity model, and the running the mathematical framework to generate results including:
determining calculated profits for a plurality of channels;
determining channels to utilize in the marketing campaign; and
identifying leads to utilize in such channels;
outputting, by the computer, the results; and
processing marketing campaign results, wherein processing comprises analyzing the marketing campaign results for each of the plurality of channels to determine the effectiveness of the marketing campaign per channel,
wherein the results comprise (i) which plurality channels of the multiple channels to use in the marketing campaign, (ii) a sequence in which to utilize the plurality of channels, (iii) which specific customers to extend the offer to, and (iv) a timing of each offer; and
implementing the results in the marketing campaign, such implementation of the results including effecting the marketing campaign over the channels to identified customers as dictated by the results.

2. The method of claim 1, further including imposing constraints upon the mathematical framework, prior to running the mathematical framework.

3. The method of claim 2, wherein the constraints include both cost constraints and capability constraints.

4. (canceled)

5. The method of claim 1, wherein the results include time duration related data related to utilization of the multiple channels.

6. The method of claim 1, further including imposing both the boosting factors and the deterioration factors upon the mathematical framework, prior to running the mathematical framework.

7. The method of claim 6, wherein imposing a deterioration factor includes associating a purchase of a single product, by a customer, with plural channels over which the customer received marketing for the single product.

8. The method of claim 1, further including imposing both customer eligibility criteria and customer preference criteria upon the mathematical framework, prior to running the mathematical framework.

9. The method of claim 1, wherein the implementation of the marketing campaign further includes implementation of the results resulting in yielded data, the yielded data containing information regarding actual results of the marketing campaign.

10. The method of claim 9, further including incorporating the yielded data into the mathematical framework.

11. The method of claim 1, wherein the mathematical framework, to optimize the utilization of the channels, is based on an optimization of profits over all the utilized channels.

12. The method of claim 1, wherein the mathematical framework, to optimize the utilization of the channels, is based on an optimization of revenue over all the utilized channels.

13. The method of claim 1, wherein the running the mathematical framework to generate results includes:
determining which leads are favored leads in each respective channel based on the mathematical representation of the respective candidate channels.

14. The method of claim 13, wherein the running the mathematical framework to generate results further includes pushing up the favored leads, from each channel, so as to generate a favored leads set; and
determining leads, in the favored leads set, that are optimum leads.

15. The method of claim 14, wherein the determining leads, in the favored leads set, that are the optimum leads is determined based on profit criteria.

16. The method of claim 15, wherein the running the mathematical framework to generate results further includes imposing a constraint relating to the number of market touches per lead.

17. A method for optimizing the utilization of multiple channels in a marketing campaign, the multiple channels each being candidates for utilization in the marketing campaign, the method implemented on a tangibly embodied computer, the method comprising:
providing, by the computer, a mathematical representation of the candidate channels;
providing, by the computer, a mathematical representation of an interrelationship between the candidate channels;
the computer automatically modifying the mathematical representation of the interrelationship between the candidate channels based on one or more prior occurrences;
providing, by the computer, a mathematical framework to optimize the utilization of the channels, the mathematical framework incorporating the mathematical representation of the candidate channels and the mathematical representation of an interrelationship between the candidate channels;
the computer automatically modifying the mathematical framework based on feedback from marketing campaign results of prior iterations of the mathematical framework;
the mathematical framework including:
a response model that determines the probability that a customer will respond to a certain product offer in a given channel; and
a propensity model that determines how an offer in one channel affects the responsiveness of a similar offer in a different channel, and running the propensity model including the computer adjusting a calculated profit for each channel based on (a) reducing calculated profit for a channel based on a product of overlap of channels and a deterioration factor, and (b) increasing calculated profit for the channel based on a product of overlap of channels and a boosting factor;
running, by the computer, the mathematical framework to generate results, including running said response model and running said propensity model, and the running the mathematical framework to generate results including:
determining calculated profits for a plurality of channels;
determining the channels to utilize in the marketing campaign; and
determining leads to utilize in such channels;
outputting, by the computer, the results; and
processing marketing campaign results, wherein processing comprises analyzing the marketing campaign results for each of the plurality of channels to determine the effectiveness of the marketing campaign per channel; and
wherein the running the mathematical framework to generate results further includes:
determining which leads are favored leads in each respective channel based on the mathematical representation of the respective candidate channels;
pushing up the favored leads, from each channel, so as to generate a favored leads set; and
determining leads, in the favored leads set, that are optimum leads; and wherein the determining leads, in the favored leads set, that are the optimum leads is determined based on profit criteria,
wherein the results comprise (i) which plurality channels of the multiple channels to use in the marketing campaign, (ii) a sequence in which to utilize the plurality of channels, (iii) which specific customers to extend the offer to, and (iv) a timing of each offer.
implementing the results in the marketing campaign, such implementation of the results including effecting the marketing campaign over the channels to identified customers as dictated by the results.

18. A computer system for optimizing the utilization of multiple channels in a marketing campaign, the multiple channels each being candidates for utilization in the marketing campaign, the computer system in the form of a tangibly embodied computer including a processor and an operatively coupled memory, the computer system comprising:
a non-transient mathematical framework data memory portion that includes:
a non-transient mathematical representation of the candidate channels;
a non-transient mathematical representation of an interrelationship between the candidate channels, comprising a deterioration factor representing an underlying deterioration cause, and the representation of the interrelationship between the candidate channels further comprising a representation of optimization of profit for each candidate channel; and
a non-transient mathematical framework to optimize the utilization of the channels, the mathematical framework incorporating the mathematical representation of the candidate channels and the mathematical representation of an interrelationship between the candidate channels;
the non-transient mathematical framework data memory portion being configured to automatically modify the mathematical framework based on feedback from marketing campaign results of prior iterations of the mathematical framework; and
the mathematical framework including:
a propensity model that determines how an offer in one channel affects the responsiveness of a similar offer in a different channel, and running the propensity model including the computer adjusting a calculated profit for each channel based on (a) reducing calculated profit for a channel based on a product of overlap of channels and the deterioration factor, and (b) increasing calculated profit for the channel based on a product of overlap of channels and a boosting factor; and
a non-transient optimization module, the optimization module running the mathematical framework to generate results, the running the mathematical framework including running the propensity model, and the running the mathematical framework to generate results including:
determining calculated profits for a plurality of channels;
determining, based on the calculated profits, the channels to utilize in the marketing campaign and
identifying leads to utilize in such channels;
the optimization module outputting the results; and
processing marketing campaign results, wherein processing comprises analyzing the marketing campaign results for each of the plurality of channels to determine the effectiveness of the marketing campaign per channel; and
wherein the running the mathematical framework to generate results includes:
determining which leads are favored leads in each respective channel based on the mathematical representation of the respective candidate channels;
pushing up the favored leads, from each channel, so as to generate a favored leads set; and
determining leads, in the favored leads set, that are optimum leads; and
wherein the determining leads, in the favored leads set, that are the optimum leads is determined based on profit criteria,
wherein the results comprise (i) which plurality channels of the multiple channels to use in the marketing campaign, (ii) a sequence in which to utilize the plurality of channels, (iii) which specific customers to extend the offer to, and (iv) a timing of each offer.
